(19) United States
(12) Patent Application Publication
(10) Pub. No.: US 2025/0080455 A1
(43) Pub. Date: Mar. 6, 2025

(54) MANAGEMENT DEVICE, RELAY DEVICE, MANAGEMENT METHOD, AND MANAGEMENT PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi (JP)

(72) Inventors: Yoshitaka KIKUCHI, Yokkaichi-shi, Mie (JP); Takeshi HAGIHARA, Yokkaichi-shi, Mie (JP); Hirofumi URAYAMA, Yokkaichi-shi, Mie (JP); Darmawan GO, Yokkaichi-shi, Mie (JP); Tomohiro OTSU, Yokkaichi-shi, Mie (JP); Hideyuki TANAKA, Osaka-shi, Osaka (JP); Tatsuya IZUMI, Osaka-shi, Osaka (JP); Yusuke YAMAMOTO, Osaka-shi, Osaka (JP); Kenta OGATA, Osaka-shi, Osaka (JP); Hideki GOTO, Toyota-shi, Aichi (JP); Yasuhiro YAMASAKI, Toyota-shi, Aichi (JP); Takashi YASUDA, Toyota-shi, Aichi (JP)

(21) Appl. No.: 18/556,130

(22) PCT Filed: Apr. 14, 2022
(86) PCT No.: PCT/JP2022/017847

§ 371 Date: May 15, 2024

(30) Foreign Application Priority Data
Apr. 26, 2021 (JP) 2021-073729

(51) Int. Cl. H04L 45/42; H04L 12/46

(52) U.S. Cl. CPC H04L 45/42; H04L 12/4604

(57) ABSTRACT

A management device includes: an acquisition unit that acquires change information from which a change in an operational state of one or more functional units included in an onboard network is discernible, and from which a change in a state of use of a transmission path in the onboard network by the functional units is discernible; and a setting change unit that performs setting change to change settings for the onboard network based on the change information acquired by the acquisition unit.

### CROSS-REFERENCE TO RELATED APPLICATIONS

This application is the U.S. national stage of PCT/JP2022/017847 filed on Apr. 14, 2022, which claims priority of Japanese Patent Application No. JP 2021-073729 filed on Apr. 26, 2021, the contents of which are incorporated herein.

### TECHNICAL FIELD

The present invention relates to a management device, a relay device, a management method, and a management program.

### BACKGROUND

WO 2020/145334 discloses the following technique: A vehicle controller controls a plurality of relays based on a control scenario by which the state of a vehicle in which a vehicle network constituted by the plurality of relays is built and the control content to be set for each of the plurality of relays are associated with each other.

There is demand for a technique that is superior to the techniques according to WO 2020/145334 and WO 2020/179123 and that realizes efficient communication using a limited bandwidth of an onboard network.

The present disclosure has been developed to solve the above-described problem, and aims to provide a management device, a relay device, a management method, and a management program for realizing efficient communication using a limited bandwidth of an onboard network.

### SUMMARY

A technique that realizes flexible changes in the configuration of an onboard network has been developed.

A management device according to the present disclosure includes: an acquisition unit that acquires change information from which a change in an operational state of one or more functional units included in an onboard network is discernible, and from which a change in a state of use of a transmission path in the onboard network by the functional units is discernible; and a setting change unit that performs setting change to change settings for the onboard network based on the change information acquired by the acquisition unit.

A relay device according to the present disclosure is a relay device that performs relay processing to relay information between a plurality of functional units included in an onboard network, the relay device includes: a detection unit that detects a change in a state of use of a transmission path in the onboard network by the functional units as a change in an operational state of the functional units; and a transmission unit that transmits change information from which a change in the state of use detected by the detection unit is discernible, to a management unit that changes settings for the onboard network.

An onboard network management method for a management device according to the present disclosure includes: a step of acquiring change information from which a change in an operational state of a functional unit included in an onboard network is discernible, and from which a change in a state of use of a transmission path in the onboard network by the functional unit is discernible; and a step of changing settings for the onboard network based on the change information thus acquired.

An onboard network management method according to the present disclosure is an onboard network management method for a relay device that performs relay processing to relay information between a plurality of functional units included in an onboard network, the method includes: a step of detecting a change in a state of use of a transmission path in the onboard network by the functional units as a change in an operational state of the functional units; and a step of transmitting change information from which a change in the state of use thus detected is discernible, to a management unit that changes settings for the onboard network.

A management program that is to be used in a management device according to the present disclosure enabling a computer to function as: an acquisition unit that acquires change information from which a change in an operational state of a functional unit included in an onboard network is discernible, and from which a change in a state of use of a transmission path in the onboard network by the functional unit is discernible; and a setting change unit that changes settings for the onboard network based on the change information acquired by the acquisition unit.

A management program according to the present disclosure is a management program that is to be used by a relay device that performs relay processing to relay information between a plurality of functional units included in an onboard network, the management program enabling a computer to function as: a detection unit that detects a change in a state of use of a transmission path in the onboard network by the functional units as a change in an operational state of the functional units; and a transmission unit that transmits change information from which a change in the state of use detected by the detection unit is discernible, to a management device that changes settings for the onboard network.

The present disclosure can be realized not only as a management device that includes such characteristic processing units, but also as a semiconductor integrated circuit that realizes a part or the entirety of the management device, or an onboard communication system that includes the management device. Also, the present disclosure can be realized not only as a relay device that includes such characteristic processing units, but also as a semiconductor integrated circuit that realizes a part or the entirety of the relay device, or an onboard communication system that includes the relay device.

### Effects of the Present Disclosure

With the present disclosure, it is possible to perform efficient communication using a limited bandwidth of the onboard network.

### BRIEF DESCRIPTION OF THE DRAWINGS

FIG. 1 is a diagram showing a configuration of an onboard communication system according to an embodiment of the present disclosure.

FIG. 2 is a diagram showing a configuration of a relay device according to an embodiment of the present disclosure.

FIG. 3 is a diagram showing a configuration of a relay device according to an embodiment of the present disclosure.

FIG. 4 is a diagram showing an example of an address table stored in the storage unit of the relay device according to an embodiment of the present disclosure.

FIG. 5 is a diagram showing a configuration of a relay device according to an embodiment of the present disclosure.

FIG. 6 is a diagram showing an example of an address table that has been updated by the setting change unit according to an embodiment of the present disclosure.

FIG. 7 is a diagram showing an example of a sequence of detection processing that is performed by a relay device according to an embodiment of the present disclosure.

FIG. 8 is a diagram showing another example of a sequence of detection processing that is performed by a relay device according to an embodiment of the present disclosure.

FIG. 9 is a diagram showing an example of a sequence of setting change processing that is performed by a management device according to an embodiment of the present disclosure.

FIG. 10 is a diagram showing an example of a sequence of communication that is performed by an onboard communication system according to an embodiment of the present disclosure.

### DETAILED DESCRIPTION OF PREFERRED EMBODIMENTS

First, the details of an embodiment of the present disclosure are listed and described.

A management device according to an embodiment of the present disclosure includes: an acquisition unit that acquires change information from which a change in an operational state of one or more functional units included in an onboard network is discernible, and from which a change in a state of use of a transmission path in the onboard network by the functional units is discernible; and a setting change unit that performs setting change to change settings for the onboard network based on the change information acquired by the acquisition unit.

With such a configuration, it is possible to build an onboard network with which efficient communication can be performed in response to a change in the state of use of the transmission path by the functional units. Therefore, it is possible to perform efficient communication using a limited bandwidth of the onboard network.

A configuration is possible in which, the acquisition unit further acquires the change information from which a change in a state of power supply from a power supply to the functional units is discernible.

With such a configuration, it is possible to perform appropriate setting change according to the state of power supply to the functional units.

A configuration is possible in which, the setting change unit performs the setting change to change settings for relay processing that is performed by a relay processing unit to relay information between a plurality of functional units included in the onboard network.

With such a configuration, it is possible to enable the relay processing unit to perform efficient relay processing, based on the operation state of a functional unit, to relay information between the functional unit and another functional unit.

A configuration is possible in which, the setting change unit performs the setting change to change bandwidth allocation to a transmission path included in the onboard network used by the functional units to perform communication.

With such a configuration, it is possible to reduce or increase the bandwidths allocated to the functional units, and therefore it is possible to perform efficient communication in the onboard network.

A configuration is possible in which, the setting change unit allocates at least a portion of a bandwidth allocated to one functional unit of the plurality of functional units for the one functional unit to perform communication using the transmission path, to another functional unit of the plurality of functional units.

With such a configuration, it is possible to effectively use the bandwidth of the onboard network by, for example, allocating the bandwidth allocated to a functional unit whose communication volume has decreased due to a change in the operational state thereof, to another functional unit.

A relay device according to an embodiment of the present disclosure is a relay device that performs relay processing to relay information between a plurality of functional units included in an onboard network, the relay device includes: a detection unit that detects a change in a state of use of a transmission path in the onboard network by the functional units as a change in an operational state of the functional units; and a transmission unit that transmits change information from which a change in the state of use detected by the detection unit is discernible, to a management unit that changes settings for the onboard network.

With such a configuration, in the management unit, for example, it is possible to build an onboard network with which efficient communication can be performed in response to a change in the state of use of the transmission path by the functional units. Therefore, it is possible to perform efficient communication using a limited bandwidth of the onboard network.

A configuration is possible in which, the detection unit further detects a state of power supply from a power supply to the functional units as a change in the operational state, and the transmission unit further transmits the change information from which a change in the state of power supply detected by the detection unit is discernible, to the management unit.

With such a configuration, in the management unit, for example, it is possible to perform appropriate setting change according to the state of power supply to the functional units.

An onboard network management method for a management device according to an embodiment of the present disclosure includes: a step of acquiring change information from which a change in an operational state of a functional unit included in an onboard network is discernible, and from which a change in a state of use of a transmission path in the onboard network by the functional unit is discernible; and a step of changing settings for the onboard network based on the change information thus acquired.

With such a method, it is possible to build an onboard network with which efficient communication can be performed in response to a change in the state of use of the transmission path by the functional units. Therefore, it is possible to perform efficient communication using a limited bandwidth of the onboard network.

An onboard network management method according to an embodiment of the present disclosure is an onboard network management method for a relay device that performs relay processing to relay information between a plurality of functional units included in an onboard network, the method includes: a step of detecting a change in a state of use of a transmission path in the onboard network by the functional units as a change in an operational state of the functional units; and a step of transmitting change information from which a change in the state of use thus detected is discernible, to a management unit that changes settings for the onboard network.

With such a method, in the management unit, for example, it is possible to build an onboard network with which efficient communication can be performed in response to a change in the state of use of the transmission path by the functional units. Therefore, it is possible to perform efficient communication using a limited bandwidth of the onboard network.

A management program that is to be used in a management device according to an embodiment of the present disclosure enabling a computer to function as: an acquisition unit that acquires change information from which a change in an operational state of a functional unit included in an onboard network is discernible, and from which a change in a state of use of a transmission path in the onboard network by the functional unit is discernible; and a setting change unit that changes settings for the onboard network based on the change information acquired by the acquisition unit.

With such a configuration, it is possible to build an onboard network with which efficient communication can be performed in response to a change in the state of use of the transmission path by the functional units. Therefore, it is possible to perform efficient communication using a limited bandwidth of the onboard network.

A management program according to an embodiment of the present disclosure is a management program that is to be used by a relay device that performs relay processing to relay information between a plurality of functional units included in an onboard network, the management program enabling a computer to function as: a detection unit that detects a change in a state of use of a transmission path in the onboard network by the functional units as a change in an operational state of the functional units; and a transmission unit that transmits change information from which a change in the state of use detected by the detection unit is discernible, to a management device that changes settings for the onboard network.

With such a configuration, in the management unit, for example, it is possible to build an onboard network with which efficient communication can be performed in response to a change in the state of use of the transmission path by the functional units. Therefore, it is possible to perform efficient communication using a limited bandwidth of the onboard network.

Hereinafter, embodiments of the present invention will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### Configuration and Basic Operation

### Onboard Communication System

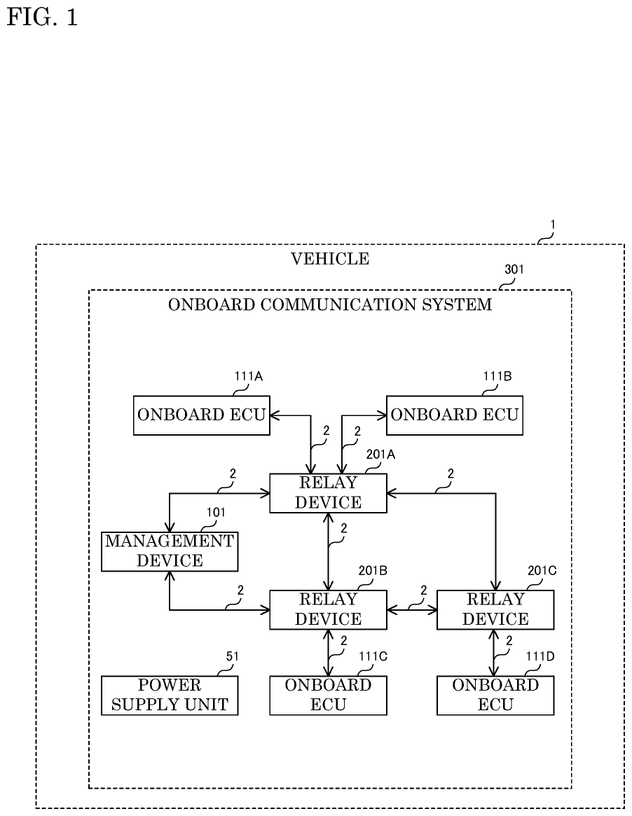

FIG. 1 is a diagram showing a configuration of an onboard communication system according to an embodiment of the present disclosure. As shown in FIG. 1, an onboard communication system 301 includes a management device 101, relay devices 201A, 201B, and 201C, onboard ECUs (Electronic Control Units) 111A, 111B, 111C, and 111D, and a power supply unit 51. Hereinafter, each of the relay devices 201A, 201B, and 201C may also be referred to as a relay device 201, and each of the onboard ECUs 111A, 111B, 111C, and 111D may also be referred to as an onboard ECU 111. The relay devices 201 are examples of the relay processing unit and examples of the onboard device. The onboard ECUs 111 are examples of the functional unit and examples of the onboard device. The management device 101 is an example of the management unit and an example of the onboard device. The onboard communication system 301 is installed in a vehicle 1. That is to say, the management device 101, the relay devices 201, the onboard ECUs 111, and the power supply unit 51 are installed in the vehicle 1.

The onboard communication system 301 is not limited to having a configuration including one management device 101, and may have a configuration including two or more management devices 101. In addition, the onboard communication system 301 is not limited to having a configuration including three relay devices 201, and may have a configuration including one, two, four, or more relay devices 201. In addition, the onboard communication system 301 is not limited to having a configuration including four onboard ECUs 111, and may have a configuration including one, two, three, five, or more onboard ECUs 111.

The relay device 201A and the relay device 201B are connected to each other via a cable 2. The relay device 201B and the relay device 201C are connected to each other via a cable 2. The relay device 201C and the relay device 201A are connected to each other via a cable 2. The relay device 201A is connected to the management device 101, the onboard ECU 111A, and the onboard ECU 111B via cables 2. The relay device 201B is connected to the management device 101 and the onboard ECU 111C via cables 2. The relay device 201C is connected to the onboard ECU 111D via a cable 2. The cables 2 are, for example, Ethernet (registered trademark) cables. The management device 101, the relay devices 201, the onboard ECUs 111, and the cables 2 constitute an onboard network.

Examples of the onboard ECUs 111 include an electric power steering (EPS), a brake control device, an accelerator control device, a steering control device, a driver assistance device that provides instructions to various devices in an advanced driver-assistance system (ADAS), and sensors.

Each relay device 201 transmits an NM (Network Management) message conforming to AUTOSAR (AUTomotive Open System ARchitecture), to the onboard ECUs 111 connected thereto. Specifically, each relay device 201 transmits an Ethernet frame storing an NM message to the onboard ECUs 111 connected thereto, at regular intervals, for example.

The onboard ECUs 111 transition from a wake-up state to a sleep state when the arrival of periodic NM messages from the relay devices 201 stops. The onboard ECUs 111 transition from a sleep state to a wake-up state when the arrival of periodic NM messages from the relay devices 201 starts. In this way, by using NM messages to switch the state of each onboard ECU 111 between a sleep state and a wake-up state, power consumption in the onboard communication system 301 can be reduced.

Each relay device 201 performs relay processing to relay information between the plurality of onboard ECUs 111 in the onboard network. More specifically, each relay device 201 receives an Ethernet frame storing various information from an onboard ECU 111, and transmits the received Ethernet frame to the onboard ECU 111 at the destination directly or via another relay device 201.

Each relay device 201 performs relay processing to relay information between another relay device 201 and the management device 101. More specifically, each relay device 201 receives an Ethernet frame storing various information from another relay device 201, and transmits the received Ethernet frame to the management device 101. In addition, each relay device 201 receives an Ethernet frame storing various information from the management device 101, and transmits the received Ethernet frame to the relay device 201 at the destination directly or via another relay device 201.

The management device 101 changes settings for the onboard network. More specifically, the management device 101 generates setting information to change the settings for the relay processing that is performed by a relay device 201, for example, according to changes in the operational state of an onboard ECU 111, and transmits an Ethernet frame storing the generated setting information to the relay device 201 at the destination directly or via the aforementioned relay device 201. The relay device 201 acquires setting information from the received Ethernet frame, and changes settings for relay processing based on the acquired setting information.

The power supply unit 51 supplies power to the management device 101, the relay devices 201, and the onboard ECUs 111. For example, the power supply unit 51 includes a plurality of types of power supplies such as a constant power supply, an ignition power supply, and an accessory power supply. The power supply unit 51 supplies power from a power supply of a type corresponding to the operational state of the vehicle 1 to a predetermined onboard ECU 111.

More specifically, the onboard communication system 301 includes an onboard ECU 111 to be powered by a constant power supply, an onboard ECU 111 to be powered by an accessory power supply, and an onboard ECU 111 to be powered by an ignition power supply. The power supply unit 51 supplies power from a constant power supply to the onboard ECU 111 to be powered by a constant power supply when the vehicle 1 is in an OFF state, supplies power from an accessory power supply to the onboard ECU 111 to be powered by an accessory power supply when the vehicle 1 is in an accessory-ON state, and supplies power from an ignition power supply to the onboard ECU 111 to be powered by an ignition power supply when the vehicle 1 is in an ignition state.

### Relay Devices

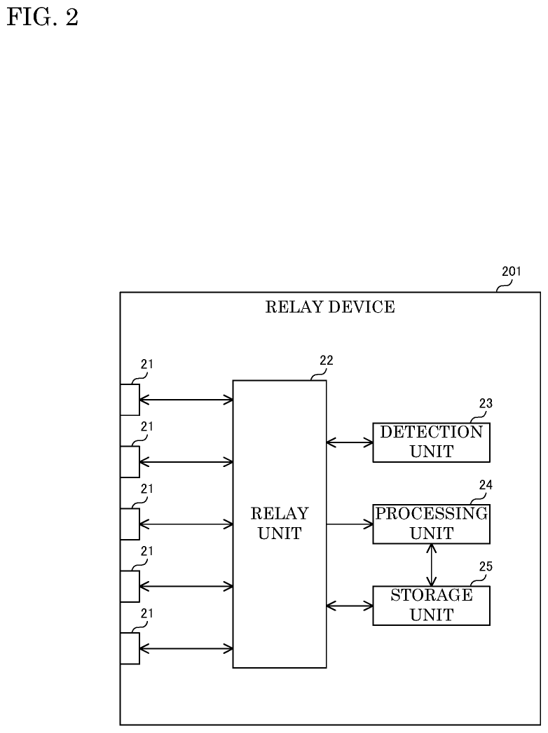

FIG. 2 is a diagram showing a configuration of a relay device according to an embodiment of the present disclosure. As shown in FIG. 2, the relay device 201 includes five communication ports 21, a relay unit 22, a detection unit 23, a processing unit 24, and a storage unit 25. The relay unit 22 is an example of the transmission unit. Note that the relay device 201 is not limited to having a configuration including five communication ports 21, and may have a configuration including two, three, four, six, or more communication ports 21.

The communication ports 21 are, for example, terminals to which cables 2 can be connected. Note that the communication ports 21 may be terminals of an integrated circuit. Some or all of the five communication ports 21 are connected to other onboard devices via cables 2.

The relay unit 22, the detection unit 23, and the processing unit 24 are realized using a processor such as a CPU (Central Processing Unit) or a DSP (Digital Signal Processor), for example. The storage unit 25 is, for example, a nonvolatile memory.

For example, at regular intervals, the detection unit 23 includes an NM message in an Ethernet frame and transmits such an Ethernet frame to the onboard ECU 111 connected to the relay device 201 including the detection unit 23, via the relay unit 22 and the communication ports 21.

### Relay Processing

The relay unit 22 performs relay processing to relay information between the plurality of onboard ECUs 111. That is to say, the relay unit 22 receives Ethernet frames transmitted from the onboard ECUs 111, via the communication ports 21, and performs relay processing on the received Ethernet frames. For example, the relay unit 22 can function as an L2 switch, and performs relay processing on Ethernet frames transmitted between the onboard ECUs 111 connected to the relay device 201 including the relay unit 22. In addition, for example, the relay unit 22 can function as an L3 switch, and performs relay processing on Ethernet frames transmitted between the onboard ECUs 111 connected to different relay devices 201.

In addition, the relay unit 22 performs relay processing to relay information between the management device 101 and other relay devices 201. That is to say, the relay unit 22 receives Ethernet frames transmitted from the management device 101 or other relay devices 201, via the communication ports 21, and performs relay processing on the received Ethernet frames.

More specifically, the storage unit 25 stores an address table Tb indicating the correspondence relationship between: source IP (Internet Protocol) addresses and destination IP addresses contained in Ethernet frames; and the port numbers of the communication ports 21.

The relay unit 22 references the address table Tb stored in the storage unit 25, and specifies the port number corresponding to the source IP address and the destination IP address contained in the Ethernet frame on which relay processing is to be performed. Thereafter, the relay unit 22 transmits the Ethernet frame to an onboard ECU 111, the management device 101, or another relay device 201 via the communication port 21 having the specified port number.

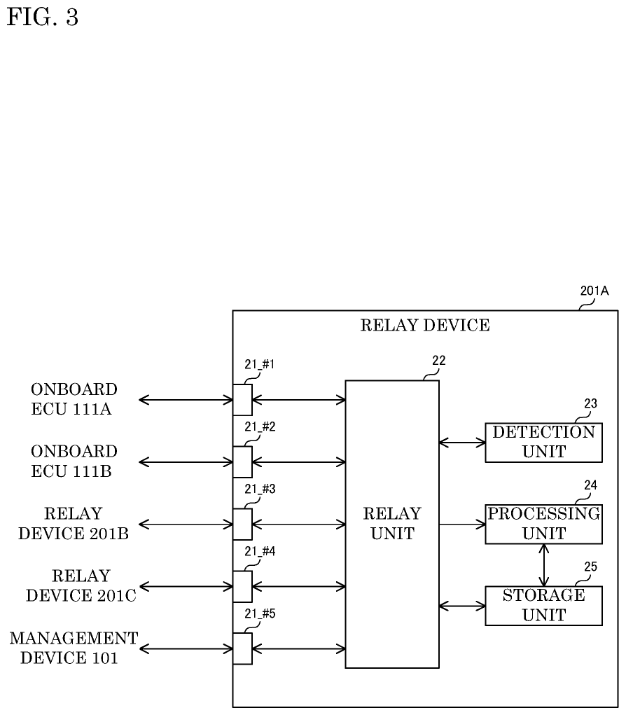

FIG. 3 is a diagram showing a configuration of a relay device according to an embodiment of the present disclosure. FIG. 3 shows a configuration of the relay device 201A. As shown in FIG. 3, in the relay device 201A, a communication port 21_#1 having a port number “#1” is connected to the onboard ECU 111A via a cable 2. A communication port 21_#2 having a port number “#2” is connected to the onboard ECU 111B via a cable 2. A communication port 21_#3 having a port number “#3” is connected to the relay device 201B via a cable 2. A communication port 21_#4 having a port number “#4” is connected to the relay device 201C via a cable 2. A communication port 21_#5 having a port number “#5” is connected to the management device 101 via a cable 2.

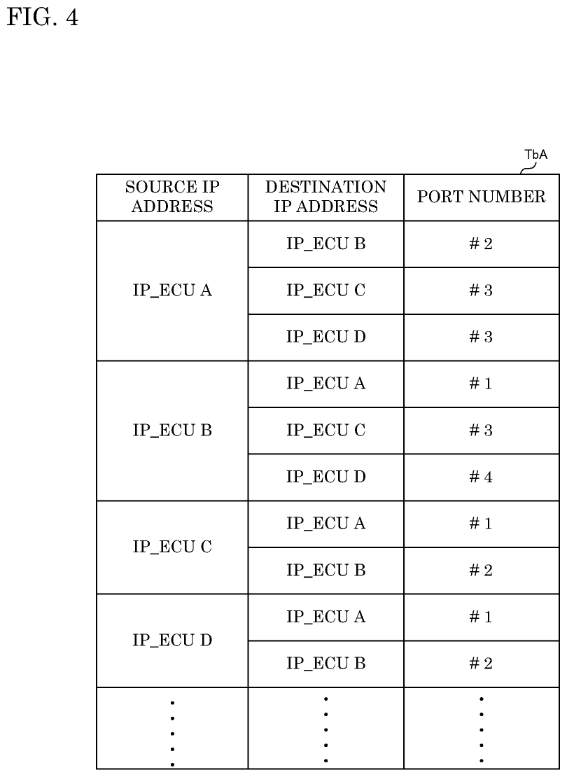

FIG. 4 is a diagram showing an example of an address table stored in the storage unit of the relay device according to an embodiment of the present disclosure. FIG. 4 shows an address table TbA stored in the storage unit 25 of the relay device 201A. Here, “IP_ECU A” represents the IP address of the onboard ECU 111A, “IP_ECU B” represents the IP address of the onboard ECU 111B, “IP_ECU C” represents the IP address of the onboard ECU 111C, and “IP_ECU D” represents the IP address of the onboard ECU 111D.

As shown in FIGS. 3 and 4, for example, when the relay unit 22 of the relay device 201A receives an Ethernet frame that contains “IP_ECU A” and IP_ECU D” as the source IP address and the destination IP address, respectively, the relay unit 22 specifies “#3” as the port number corresponding to the source IP address and the destination IP address. Thereafter, the relay unit 22 transmits the Ethernet frame to the relay device 201B via the communication port 21_#3. The relay device 201B performs relay processing in a similar manner to the relay device 201A, and transmits the Ethernet frame received from the relay device 201A to the relay device 201C. The relay device 201C performs relay processing in a similar manner to the relay device 201A, and transmits the Ethernet frame received from the relay device 201B to the onboard ECU 111D. That is to say, the Ethernet frame addressed to the onboard ECU 111D from the onboard ECU 111A is transmitted to the onboard ECU 111D via the relay device 201A, the relay device 201B, and the relay device 201C in this order.

Also, for example, when the relay unit 22 of the relay device 201A receives an Ethernet frame that contains “IP_ECU B” and “IP_ECU D” as the source IP address and the destination IP address, respectively, the relay unit 22 specifies “#4” as the port number corresponding to the source IP address and the destination IP address. Thereafter, the relay unit 22 transmits the Ethernet frame to the relay device 201C via the communication port 21_#4. The relay device 201C performs relay processing in a similar manner to the relay device 201A, and transmits the Ethernet frame received from the relay device 201A to the onboard ECU 111D. That is to say, the Ethernet frame addressed to the onboard ECU 111D from the onboard ECU 111B is transmitted to the onboard ECU 111D via the relay device 201A and the relay device 201C in this order.

### Detection Processing

Again, as shown in FIG. 2, the detection unit 23 performs detection processing to detect changes in the operational state of an onboard ECU 111. More specifically, the detection unit 23 detects changes in the operational state of the onboard ECU 111 connected to the relay device 201 including the detection unit 23, as the detection target onboard ECU 111. Thereafter, the detection unit 23 generates change information from which changes in the operational state of the detection target onboard ECU 111 is discernible, and outputs an Ethernet frame containing the generated change information to the relay unit 22.

The relay unit 22 transmits the change information from which changes in the operational state of the onboard ECU 111 detected by the detection unit 23 is discernible, to the management device 101. More specifically, the relay unit 22 receives the Ethernet frame containing the change information from the detection unit 23, and transmits the received Ethernet frame to the management device 101 via the communication port 21.

### Detection Example 1

The detection unit 23 detects changes in the state of use of a transmission path in the onboard network by an onboard ECU 111, as changes in the operational state of the onboard ECU 111. More specifically, the detection unit 23 detects changes in the state of use, by the detection target onboard ECU 111, of the cable 2 connecting the relay device 201 including the detection unit 23, and the onboard ECU 111.

For example, an onboard ECU 111 includes an NM message in an Ethernet frame and transmits such an Ethernet frame to the relay device 201 connected to the onboard ECU 111, at regular intervals. When spontaneously transitioning from a wake-up state to a sleep state, the onboard ECU 111 stops transmitting NM messages to the onboard ECU 111. When spontaneously transitioning from a sleep state to a wake-up state, the onboard ECU 111 starts transmitting NM messages to the relay device 201 at regular intervals.

The detection unit 23 receives NM messages from the onboard ECU 111 via the communication port 21 and the relay unit 22. More specifically, the relay unit 22 receives an Ethernet frame containing an NM message addressed to the relay device 201 including the relay unit 22, from the onboard ECU 111 via the communication port 21, and outputs the received Ethernet frame to the detection unit 23. The detection unit 23 receives the Ethernet frame from the relay unit 22, and acquires the NM message from the received Ethernet frame.

The detection unit 23 receives an NM message from the detection target onboard ECU 111, and recognizes that the detection target onboard ECU 111 is in a wake-up state.

For example, when the arrival of NM messages from the detection target onboard ECU 111 stops, the detection unit 23 determines that the state of the detection target onboard ECU 111 has transitioned from a wake-up state to a sleep state, and the state of use of the cable 2 by the detection target onboard ECU 111 has transitioned from an ON state to an OFF state. Thereafter, the detection unit 23 generates change information indicating that the state of use of the cable 2 by the detection target onboard ECU 111 has transitioned from an ON state to an OFF state, and outputs an Ethernet frame containing the generated change information to the relay unit 22. In addition, the detection unit 23 stops transmitting NM messages to the onboard ECU 111.

For example, when the arrival of NM messages from the detection target onboard ECU 111 starts, the detection unit 23 determines that the state of the detection target onboard ECU 111 has transitioned from a sleep state to a wake-up state, and the state of use of the cable 2 by the detection target onboard ECU 111 has transitioned from an OFF state to an ON state. Thereafter, the detection unit 23 generates change information indicating that the state of use of the cable 2 by the detection target onboard ECU 111 has transitioned from an OFF state to an ON state, and outputs an Ethernet frame containing the generated change information to the relay unit 22. In addition, the detection unit 23 starts transmitting NM messages to the onboard ECU 111 at regular intervals.

The relay unit 22 transmits the change information indicating changes in the state of use of the cable 2 by the onboard ECU 111 detected by the detection unit 23, to the management device 101. More specifically, the relay unit 22 receives the Ethernet frame containing the change information from the detection unit 23, and transmits the received Ethernet frame to the management device 101 via the communication port 21.

### Detection Example 2

The detection unit 23 detects changes in the state of power supply from the power supply unit 51 to an onboard ECU 111 as changes in the operational state of the onboard ECU 111. More specifically, the detection unit 23 monitors the operational state of the vehicle 1, and detects changes in the state of power supply to the detection target onboard ECU 111 based on the monitoring result.

For example, suppose a case where the detection target onboard ECU 111 to be detected by the detection unit 23 is an onboard ECU 111 to be powered only by an ignition power supply from among a constant power supply, an accessory power supply, and an ignition power supply.

In this case, for example, upon detecting that the state of the vehicle 1 has transitioned from an ignition-ON state to an OFF state, the detection unit 23 determines that the state of power supply to the detection target onboard ECU 111 has transitioned from an ON state to an OFF state. Thereafter, the detection unit 23 generates change information indicating that the state of power supply from the power supply unit 51 to the detection target onboard ECU 111 has transitioned from an ON state to an OFF state, and outputs an Ethernet frame containing the generated change information to the relay unit 22. In addition, the detection unit 23 stops transmitting NM messages to the onboard ECU 111.

For example, upon detecting that the state of the vehicle 1 has transitioned from an accessory-ON state to an ignition-ON state, the detection unit 23 determines that the state of power supply to the detection target onboard ECU 111 has transitioned from an OFF state to an ON state. Thereafter, the detection unit 23 generates change information indicating that the state of power supply from the power supply unit 51 to the detection target onboard ECU 111 has transitioned from an OFF state to an ON state, and outputs an Ethernet frame containing the generated change information to the relay unit 22. In addition, the detection unit 23 starts transmitting NM messages to the onboard ECU 111 at regular intervals.

The relay unit 22 transmits the change information indicating changes in the state of power supply to the onboard ECU 111 detected by the detection unit 23 to the management device 101. More specifically, the relay unit 22 receives the Ethernet frame containing the change information from the detection unit 23, and transmits the received Ethernet frame to the management device 101 via the communication port 21.

### Management Device

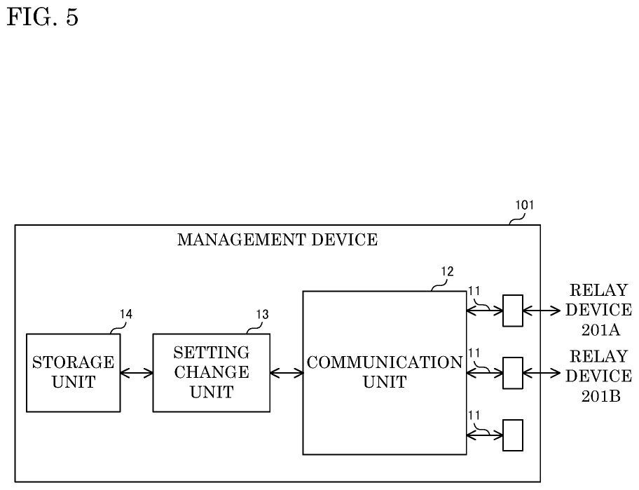

FIG. 5 is a diagram showing a configuration of a relay device according to an embodiment of the present disclosure. As shown in FIG. 5, the management device 101 includes three communication ports 11, a communication unit 12, a setting change unit 13, and a storage unit 14. The communication unit 12 is an example of the acquisition unit. Note that the management device 101 is not limited to having a configuration including three communication ports 11, and may have a configuration including one, two, four, or more communication ports 11.

The communication ports 11 are, for example, terminals to which cables 2 can be connected. Note that the communication ports 11 may be terminals of an integrated circuit. For example, two of the three communication ports 11 are respectively connected to the relay devices 201A and 201B via cables 2.

The communication unit 12 and the setting change unit 13 are realized using a processor such as a CPU or a DSP, for example. The storage unit 14 is, for example, a nonvolatile memory.

The storage unit 14 stores a plurality of types of address tables Tb to be used by the relay devices 201 to perform relay processing.

The communication unit 12 acquires change information from which changes in the operational state of each onboard ECU 111 in the onboard network is discernible. For example, the communication unit 12 acquires change information indicating a change in the state of use of a cable 2 in the onboard network by an onboard ECU 111. In another example, the communication unit 12 acquires change information indicating changes in the state of power supply from the power supply unit 51 to an onboard ECU 111.

More specifically, the communication unit 12 receives an Ethernet frame from a corresponding relay device 201 via a communication port 11, and acquires change information from the received Ethernet frame. The communication unit 12 outputs the acquired change information to the setting change unit 13.

The setting change unit 13 performs setting change to change the settings of the onboard network based on the change information acquired by the communication unit 12. More specifically, the setting change unit 13 performs the setting change to change the settings for the relay processing to be performed by the relay devices 201.

See FIG. 1 again. For example, the setting change unit 13 receives change information indicating that the state of use of the cable 2 between the relay device 201A and the onboard ECU 111B by the onboard ECU 111B has transitioned from an ON state to an OFF state, from the communication unit 12. Alternatively, the setting change unit 13 receives change information indicating that the state of power supply from the power supply unit 51 to the onboard ECU 111B has transitioned from an ON state to an OFF state, from the communication unit 12.

In this case, the setting change unit 13 performs setting change to change settings for the relay processing to be performed by the relay device 201A connected to the onboard ECU 111B, based on the change information received from the communication unit 12.

For example, the setting change unit 13 performs the setting change to change the bandwidth allocation to the cables 2 in the onboard network used by the onboard ECUs 111 to perform communication. For example, the setting change unit 13 allocates at least a portion of the bandwidth allocated to an onboard ECU 111 for the onboard ECU 111 to perform communication using the cable 2, to another onboard ECU 111.

More specifically, as described above, the Ethernet frame addressed to the onboard ECU 111D from the onboard ECU 111A is transmitted to the onboard ECU 111D via the relay device 201A, the relay device 201B, and the relay device 201C in this order. The setting change unit 13 performs the setting change based on the change information received from the communication unit 12, to change the settings for the relay processing to be performed by the relay device 201A, so that a portion of the Ethernet frame addressed to the onboard ECU 111D from the onboard ECU 111A is transmitted to the onboard ECU 111D via the relay device 201A and the relay device 201C in this order.

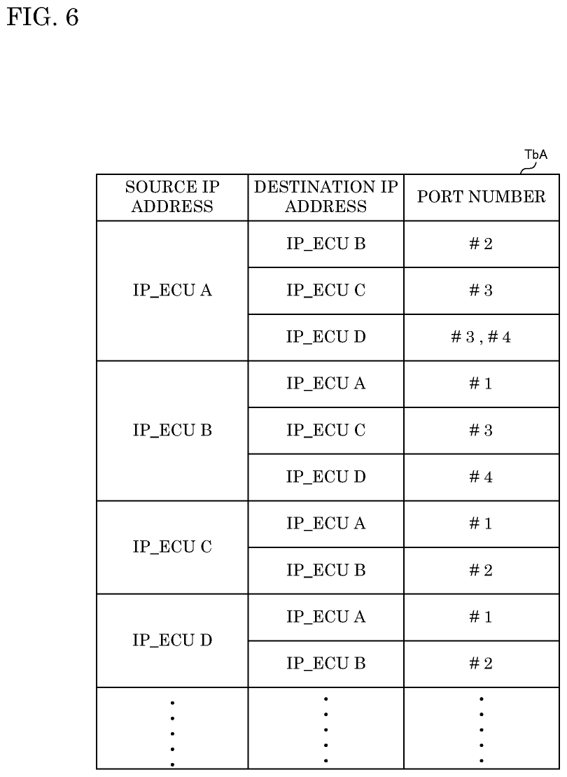

FIG. 6 is a diagram showing an example of an address table that has been updated by the setting change unit according to an embodiment of the present disclosure. As shown in FIG. 6, the setting change unit 13 updates the address table TbA to be used by the relay device 201A to perform relay processing, of the three address tables Tb stored in the storage unit 14. More specifically, the setting change unit 13 updates the address table TbA in the storage unit 14 to an address table TbA in which “#4” has been added to the port number corresponding to the source IP address “IP_ECU A” and the destination IP address “IP_ECU D”.

The setting change unit 13 outputs setting information indicating the updated address table TbA to the communication unit 12.

The communication unit 12 generates an Ethernet frame containing the setting information received from the setting change unit 13, and transmits the generated Ethernet frame to the relay device 201A via a communication port 11.

See FIG. 3 again. The relay unit 22 in the relay device 201A receives the Ethernet frame containing the setting information from the management device 101 via the communication port 21_#5, and outputs the received Ethernet frame to the processing unit 24.

The processing unit 24 acquires the setting information from the Ethernet frame received from the relay unit 22, and updates the address table TbA in the storage unit 25 to the updated address table TbA indicated by the acquired setting information.

Thereafter, when the relay unit 22 of the relay device 201A receives an Ethernet frame that contains “IP_ECU A” and “IP_ECU D” as the source IP address and the destination IP address, respectively, the relay unit 22 specifies “#3” and “#4” as the port numbers corresponding to the source IP address and the destination IP address. For example, the relay unit 22 transmits some Ethernet frames of a plurality of Ethernet frames received in a certain period to the relay device 201B via the communication port 21_#3, and transmits the remaining Ethernet frames of the plurality of Ethernet frames received in the period to the relay device 201C via the communication ports 21_#4. The relay device 201B performs relay processing in a similar manner to the relay device 201A, and transmits the Ethernet frames received from the relay device 201A to the relay device 201C. The relay device 201C performs relay processing in a similar manner to the relay device 201A, and transmits the Ethernet frames received from the relay device 201B to the onboard ECU 111D.

That is to say, some of the plurality of Ethernet frames addressed to the onboard ECU 111D from the onboard ECU 111A are transmitted to the onboard ECU 111D via the relay device 201A, the relay device 201B, and the relay device 201C in this order. The rest of the plurality of Ethernet frames addressed to the onboard ECU 111D from the onboard ECU 111A are transmitted to the onboard ECU 111D via the relay device 201A, and the relay device 201C in this order.

Thereafter, for example, the setting change unit 13 receives change information indicating that the state of use of the cable 2 between the relay device 201A and the onboard ECU 111B by the onboard ECU 111B has transitioned from an OFF state to an ON state, from the communication unit 12. Alternatively, the setting change unit 13 receives change information indicating that the state of power supply from the power supply unit 51 to the onboard ECU 111B has transitioned from an OFF state to an ON state, from the communication unit 12.

In this case, the setting change unit 13 performs setting change to change settings for the relay processing to be performed by the relay device 201A connected to the onboard ECU 111B, based on the change information received from the communication unit 12. More specifically, the setting change unit 13 updates the address table TbA in the storage unit 14 to an address table TbA in which “#4” has been deleted from the port numbers corresponding to the source IP address “IP_ECU A” and the destination IP address “IP_ECU D”, and outputs setting information indicating the updated address table TbA to the communication unit 12.

The communication unit 12 generates an Ethernet frame containing the setting information received from the setting change unit 13, and transmits the generated Ethernet frame to the relay device 201A via a communication port 11.

The processing unit 24 of the relay device 201A receives the Ethernet frame from the management device 101 via the communication port 22_#5 and the relay unit 22. The processing unit 24 acquires the setting information from the received Ethernet frame, and updates the address table TbA in the storage unit 25 to the updated address table TbA indicated by the acquired setting information.

The devices in the onboard communication system according to an embodiment of the present disclosure each have a computer that includes a memory, and in each of such devices, an arithmetic processing unit such as a CPU in the computer reads out, from the memory, a program that includes part or all of the steps of the sequence described below, and executes the program. The programs executed by the devices can be installed from an external source. The programs executed by the devices are distributed in a state of being stored in recording media or distributed via a communication line.

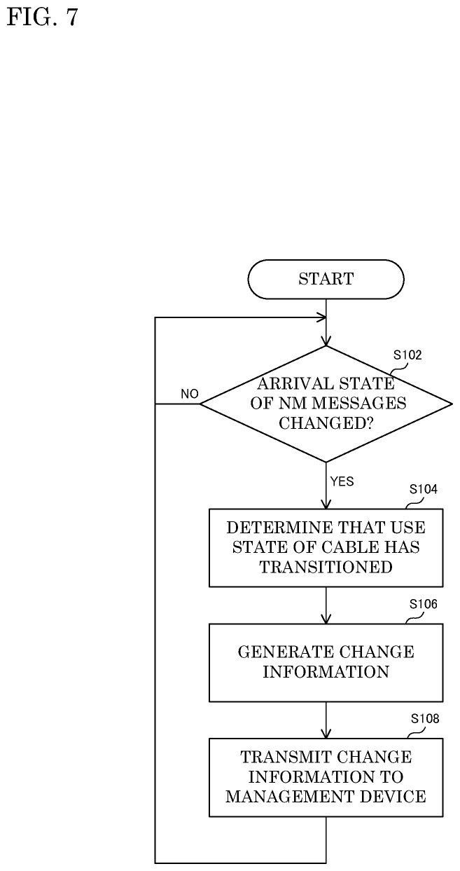

FIG. 7 is a diagram showing an example of a sequence of detection processing that is performed by a relay device according to an embodiment of the present disclosure. As shown in FIG. 7, first, the relay device 201 waits for a change in the arrival state of NM messages from the detection target onboard ECU 111 (NO in step S102), and, for example, when the arrival of NM messages from the detection target onboard ECU 111 stops (YES in step S102), the relay device 201 determines that the operational state of the detection target onboard ECU 111 has changed. Specifically, the relay device 201 determines that the state of use of the cable 2 by the detection target onboard ECU 111 has transitioned from an ON state to an OFF state (step S104).

Next, the relay device 201 generates change information indicating that the state of use of the cable 2 by the detection target onboard ECU 111 has transitioned from an ON state to an OFF state (step S106).

Next, the relay device 201 transmits the generated change information to the management device 101 (step S108).

Next, the relay device 201 waits for a new change in the arrival state of NM messages from the detection target onboard ECU 111 (NO in step S102).

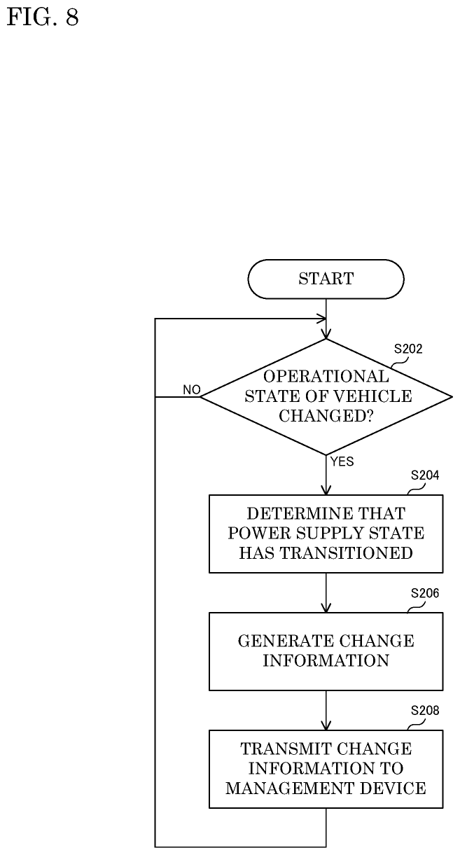

FIG. 8 is a diagram showing another example of a sequence of detection processing that is performed by a relay device according to an embodiment of the present disclosure. As shown in FIG. 8, first, the relay device 201 waits for a change in the operational state of the vehicle 1 (NO in step S202), and, for example, when the relay device 201 detects that the state of the vehicle 1 has transitioned from an ignition-ON state to an ignition-OFF state (YES in step S202), the relay device 201 determines that the operational state of the detection target onboard ECU 111 has changed. Specifically, the relay device 201 determines that the state of power supply to the detection target onboard ECU 111 has transitioned from an ON state to an OFF state (step S204).

Next, the relay device 201 generates change information indicating that the state of power supply from the power supply unit 51 to the detection target onboard ECU 111 has transitioned from an ON state to an OFF state (step S206).

Next, the relay device 201 transmits the generated change information to the management device 101 (step S208).

Next, the relay device 201 waits for a new change in the operational state of the vehicle 1 (NO in step S202).

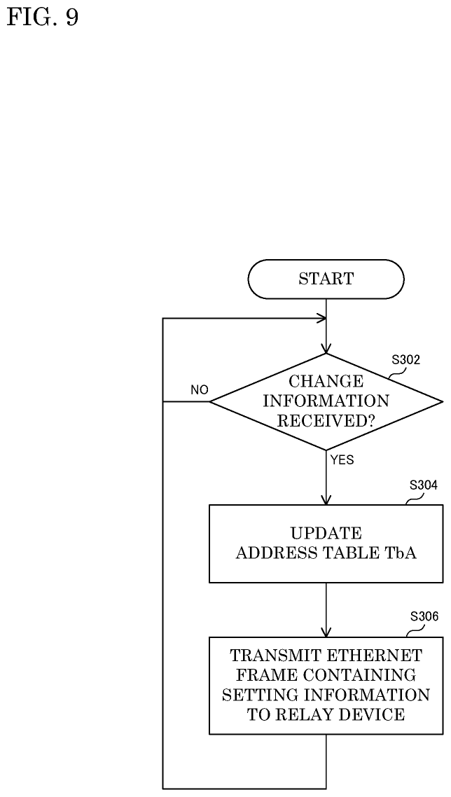

FIG. 9 is a diagram showing an example of a sequence of setting change processing that is performed by a management device according to an embodiment of the present disclosure. As shown in FIG. 9, first, the management device 101 waits for an Ethernet frame containing change information (NO in step S302), and when the management device 101 receives an Ethernet frame containing change information from a relay device 201 (YES in step S302), the management device 101 changes the setting for the relay processing by the relay device 201A, for example, based on the change information contained in the received Ethernet frame. More specifically, the management device 101 updates the address table TbA stored in the storage unit 14 (step S304).

Next, the management device 101 transmits an Ethernet frame containing setting information indicating the updated address table TbA to the relay device 201A (step S306).

Next, the management device 101 waits for a new Ethernet frame containing change information (NO in step S302).

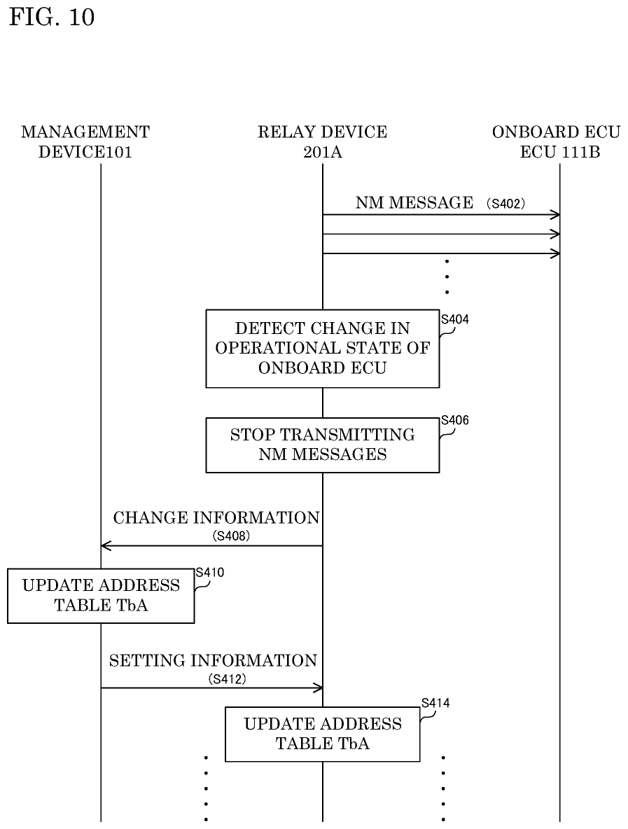

FIG. 10 is a diagram showing an example of a sequence of communication that is performed by an onboard communication system according to an embodiment of the present disclosure.

As shown in FIG. 10, first, the relay device 201A transmits Ethernet frames storing NM messages to the onboard ECU 111B at regular intervals, for example (step S402).

Next, the relay device 201A detects a change in the operational state of the onboard ECU 111B. Specifically, for example, the relay device 201A determines that the state of use of the cable 2 by the onboard ECU 111B has transitioned from an ON state to an OFF state (step S404).

Next, the relay device 201A stops transmitting NM messages to the onboard ECU 111B (step S406).

Next, the relay device 201A transmits the change information to the management device 101 (step S408).

Next, the management device 101 updates the address table TbA stored in the storage unit 14, based on the change information received from the relay device 201A (step S410).

Next, the management device 101 transmits an Ethernet frame containing setting information indicating the updated address table TbA to the relay device 201A (step S412).

Next, the relay device 201A acquires the setting information from the Ethernet frame received from the management device 101, and updates the address table TbA in the storage unit 25 to the updated address table TbA indicated by the acquired setting information (step S414).

In the onboard communication system 301 according to an embodiment of the present disclosure, the management device 101 is configured to be installed in the vehicle 1. However, the management device 101 is not limited to having such a configuration. The management device 101 may be provided outside the vehicle 1. However, in the onboard communication system 301, compared to the configuration in which the management device 101 is provided outside the vehicle 1, the configuration in which the management device 101 is installed in the vehicle 1 can suppress transmission delay in communication traffic between the relay devices 201 and the management device 101. Therefore, it is possible to change settings for the onboard network earlier in response to changes in the operational state of the onboard ECUs 111.

The onboard communication system 301 according to an embodiment of the present disclosure has a configuration in which the management device 101 and the relay devices 201 are provided as individual onboard devices. However, the onboard communication system 301 is not limited to having such a configuration. The onboard communication system 301 may have a configuration including one onboard device having the functions of the relay devices 201 and the management device 101 instead of including the relay devices 201 and the management device 101. That is to say, the management device 101 and the relay devices 201 may be integrated.

In each relay device 201 according to an embodiment of the present disclosure, the detection unit 23 is configured to generate change information indicating that the state of use of a cable 2 by the detection target onboard ECU 111 has transitioned from an OFF state to an ON state or change information indicating that the state of power supply from the power supply unit 51 to the detection target onboard ECU 111 has transitioned from an OFF state to an ON state. However, the detection unit 23 is not limited to having such a configuration. The detection unit 23 need only be configured to generate change information from which a change in the operational state of the detection target onboard ECU 111 is discernible. More specifically, the detection unit 23 may be configured to generate change information indicating that the operational state of the detection target onboard ECU 111 has changed, instead of generating change information indicating the content of a change in the operational state of the detection target onboard ECU 111. Specifically, the detection unit 23 generates change information indicating that the state of use of a cable 2 by the detection target onboard ECU 111 has changed, or change information indicating that the state of power supply from the power supply unit 51 to the detection target onboard ECU 111 has changed.

In the management device 101 according to an embodiment of the present disclosure, the setting change unit 13 is configured to change the settings for the relay processing to be performed by the relay device 201A connected to the onboard ECU 111B when receiving change information indicating a change in the operational state of the onboard ECU 111B from the communication unit 12. However, the setting change unit 13 is not limited to having such a configuration. The setting change unit 13 may be configured to change the settings for the relay processing to be performed by the relay device 201C, instead of changing the settings for the relay processing to be performed by the relay device 201A, or in addition to changing the settings for the relay processing to be performed by the relay device 201A when receiving change information indicating a change in the operational state of the onboard ECU 111B from the communication unit 12. More specifically, for example, in a state where the relay processing to be performed by the relay device 201C is set so that Ethernet frames from the onboard ECU 111D addressed to the onboard ECU 111A are transmitted to the onboard ECU 111D via the relay device 201C, the relay device 201B, and the relay device 201A in this order, when the setting change unit 13 receives change information indicating a change in the operational state of the onboard ECU 111B from the communication unit 12, the setting change unit 13 changes the settings for the relay processing to be performed by the relay device 201C so that some of the Ethernet frames from the onboard ECU 111D addressed to the onboard ECU 111A are transmitted to the onboard ECU 111A via the relay device 201C and the relay device 201A in this order.

In the management device 101 according to an embodiment of the present disclosure, the setting change unit 13 is configured to perform setting change to change the settings for the relay processing to be performed by the relay devices 201. However, the setting change unit 13 is not limited to having such a configuration. The setting change unit 13 may be configured to change the settings of the onboard ECUs 111 instead of changing the settings for relay processing. For example, the setting change unit 13 may be configured to increase or reduce the communication bandwidth of some of the onboard ECUs 111 in the onboard communication system 301.

In the management device 101 according to an embodiment of the present disclosure, the setting change unit 13 is configured to perform setting change to change the bandwidth allocation to the cables 2 used by the onboard ECUs 111 to perform communication. However, the setting change unit 13 is not limited to having such a configuration. The setting change unit 13 may be configured to perform setting change to change the settings for Ethernet frame filtering to be performed by the relay devices 201, instead of changing the bandwidth allocation to the cables 2 used by the onboard ECUs 111 to perform communication, or in addition to changing the bandwidth allocation to the cables 2 used by the onboard ECUs 111 to perform communication.

In the management device 101 according to an embodiment of the present disclosure, the setting change unit 13 is configured to allocate at least a portion of the bandwidth allocated to an onboard ECU 111 for the onboard ECU 111 to perform communication using the cable 2, to another onboard ECU 111. However, the setting change unit 13 is not limited to having such a configuration. For example, the setting change unit 13 may be configured to change at least one of the bandwidth allocated to one onboard ECU 111 and the bandwidth allocated to another onboard ECU 111, without allocating the bandwidth allocated to the one onboard ECU 111 to the other onboard ECU 111. Also, for example, the setting change unit 13 may be configured to change the settings for QoS (Quality of Service) of the Ethernet frames of the relay device 201 instead of allocating the bandwidth allocated to the onboard ECU 111, to another onboard ECU 111. Specifically, the setting change unit 13 changes the settings for the bandwidth of the onboard ECU 111 to be secured, depending on the priority of the Ethernet frames.

By the way, there is demand for a technique that realizes efficient communication using a limited bandwidth of an onboard network. More specifically, in recent years, the volume of communication in the onboard network has tended to increase due to OTA (Over The Air) updates of each onboard device in the onboard communication system 301 and the provision of streaming services to the user of the vehicle 1.

For example, depending on the state of the vehicle 1, some onboard devices in the onboard communication system 301, such as onboard devices involved in autonomous driving functions, may be temporarily idle. Conventional technology may not be able to effectively utilize the resources of the onboard network in such a situation.

In contrast, with the management device 101 according to an embodiment of the present disclosure, the communication unit 12 acquires change information from which changes in the operational state of each onboard ECU 111 in the onboard network is discernible. The setting change unit 13 performs setting change to change the settings of the onboard network based on the change information acquired by the communication unit 12.

With such a configuration, it is possible to build an onboard network with which efficient communication can be performed in response to changes in the operational state of each onboard ECU 111. Therefore, it is possible to perform efficient communication using a limited bandwidth of the onboard network.

The foregoing embodiments are to be construed in all respects as illustrative and not restrictive. The scope of the present invention is defined by the claims rather than the description above, and is intended to include all modifications within the meaning and scope of the claims and equivalents thereof.

The above description includes the features that are supplementarily noted below.

### Supplementary Note 1

An onboard communication system including a management device and a relay device that performs relay processing to relay information between a plurality of functional units included in an onboard network, wherein the relay device detects a change in an operational state of the functional units, and transmits, to the management device, change information from which the detected change in the operational state is discernible, and the management device changes settings for the onboard network based on the change information received from the relay device.

### Supplementary Note 2

A management device including an acquisition unit that acquires change information from which a change in an operational state of a functional unit included in an onboard network is discernible, and from which a change in a state of power supply from a power supply to the functional unit is discernible, and a setting change unit that changes settings for the onboard network based on the change information acquired by the acquisition unit.

### Supplementary Note 3

A relay device that performs relay processing to relay information between a plurality of functional units included in an onboard network, the relay device including a detection unit that detects a change in a state of power supply from a power supply to the functional units as a change in an operational state of the functional units, and a transmission unit that transmits change information from which a change in the state of power supply detected by the detection unit is discernible, to a management unit that performs setting change to change settings for the onboard network.

1. A management device comprising:
an acquisition unit that acquires change information from which a change in an operational state of one or more functional units included in an onboard network is discernible, and from which a change in a state of use of a transmission path in the onboard network by the functional units is discernible; and
a setting change unit that performs setting change to change settings for the onboard network based on the change information acquired by the acquisition unit.

2. The management device according to claim 1,
wherein the acquisition unit further acquires the change information from which a change in a state of power supply from a power supply to the functional units is discernible.

3. The management device according to claim 1,
wherein the setting change unit performs the setting change to change settings for relay processing that is performed by a relay processing unit to relay information between a plurality of functional units included in the onboard network.

4. The management device according to claim 1,
wherein the setting change unit performs the setting change to change bandwidth allocation to a transmission path included in the onboard network used by the functional units to perform communication.

5. The management device according to claim 4,
wherein the setting change unit allocates at least a portion of a bandwidth allocated to one functional unit of the plurality of functional units for the one functional unit to perform communication using the transmission path, to another functional unit of the plurality of functional units.

6. A relay device that performs relay processing to relay information between a plurality of functional units included in an onboard network, the relay device comprising:
a detection unit that detects a change in a state of use of a transmission path in the onboard network by the functional units as a change in an operational state of the functional units; and
a transmission unit that transmits change information from which a change in the state of use detected by the detection unit is discernible, to a management unit that changes settings for the onboard network.

7. The relay device according to claim 6,
wherein the detection unit further detects a state of power supply from a power supply to the functional units as a change in the operational state, and
the transmission unit further transmits the change information from which a change in the state of power supply detected by the detection unit is discernible, to the management unit.

8. (canceled)

9. (canceled)

10. A computer program product that is to be used in a management device, the computer program product comprising a non-transitory, machine-readable medium storing instructions which, when executed by at least one programmable processor, caused at least one programmable processor to perform operations comprising:
acquiring a change information from which a change in an operational state of a functional unit included in an onboard network is discernible, and from which a change in a state of use of a transmission path in the onboard network by the functional unit is discernible; and
changing a setting for the onboard network based on the acquired change information.

11. A computer program product that used by a relay device that performs relay processing to relay information between a plurality of functional units included in an onboard network, the computer program product comprising a non-transitory, machine-readable medium storing instructions which, when executed by at least one programmable processor, caused at least one programmable processor to perform operations comprising:
detecting a change in a state of use of a transmission path in the onboard network by the functional units as a change in an operational state of the functional units; and
transmitting a change information from which a change in the state of use detected by the detection unit is discernible, to a management device that changes settings for the onboard network.

12. The management device according to claim 2,
wherein the setting change unit performs the setting change to change settings for relay processing that is performed by a relay processing unit to relay information between a plurality of functional units included in the onboard network.

13. The management device according to claim 2,
wherein the setting change unit performs the setting change to change bandwidth allocation to a transmission path included in the onboard network used by the functional units to perform communication.

14. The management device according to claim 3,
wherein the setting change unit performs the setting change to change bandwidth allocation to a transmission path included in the onboard network used by the functional units to perform communication.
